(19) United States
(12) Patent Application Publication
(10) Pub. No.: US 2018/0350121 A1
(43) Pub. Date: Dec. 6, 2018

(54) GLOBAL ANNOTATIONS ACROSS CONTENTS

(71) Applicant: Polycom, Inc., San Jose, CA (US)

(72) Inventors: Joseph Samuel, Cedar Park, TX (US); Tingyu Xie, Austin, TX (US); Christopher Paul Large, Austin, TX (US)

(21) Appl. No.: 15/615,675

(22) Filed: Jun. 6, 2017

(51) Int. Cl. G06T 11/60; G06F 17/24; G06F 3/0488

(52) U.S. Cl. CPC G06T 11/60; G06F 17/242; G06F 3/04883; G06F 17/241

(57) ABSTRACT

Techniques of preserving annotation relationships are disclosed. The techniques are used a presentation system comprising at least one display, at least one processor coupled to the display, and a memory storing instructions, the instructions comprising instructions executable by the processor to display content on the display based on a content location, receive an annotation, group the annotation into an annotation group, determine the annotation group is related to the content based on the location of the annotation group and the content location, associate the annotation group with the content based on the determination, receive an indication of a change in the content location of the content, adjust the annotation group based on the change in the content location of the content, and display content based on the change in the content location and the adjusted annotation group.

### CROSS-REFERENCE TO RELATED APPLICATIONS

This application is related to U.S. application Ser. No. ______, filed Jun. 6, 2017, U.S. application Ser. No. ______, filed Jun. 6, 2017, U.S. application Ser. No. ______, filed Jun. 6, 2017, and to U.S. application Ser. No. ______, filed Jun. 6, 2017, the contents of which applications are entirely incorporated by reference herein.

### TECHNICAL FIELD

This disclosure is generally concerned with display systems, and more specifically presentation systems capable displaying, moving, and removing multiple pieces of content and annotations.

### BACKGROUND

A common annotation method for electronic whiteboards is to annotate using a stylus or finger to draw, underline or circle a point which a user wishes to emphasize. These annotations may also be made with respect to pieces of content. Annotations to content allows users to expand upon and give context to the content. Preserving this information as content is changed may be desirable.

### BRIEF DESCRIPTION OF THE DRAWINGS

For the purpose of illustration, there are shown in the drawings certain embodiments described in the present disclosure. In the drawings, like numerals indicate like elements throughout. It should be understood that the full scope of the inventions disclosed herein are not limited to the precise arrangements, dimensions, and instruments shown. In the drawings:

FIG. 1 illustrates an example presentation system, in accordance with an embodiment of this disclosure.

FIG. 2 illustrates a technique for managing annotations, in accordance with aspects of the present disclosure.

FIG. 3 illustrates a technique for grouping and associating annotations, in accordance with aspects of the present disclosure.

FIG. 4 illustrates grouping letters and words, in accordance to aspects of the present disclosure.

FIG. 5 illustrates a technique to preserve annotation relationships, in accordance with aspects of the present disclosure.

FIG. 6 illustrates a technique for broken annotation relationships, in accordance with aspects of the present disclosure.

FIG. 7 illustrates an example computing device, in accordance with aspects of the present disclosure.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present disclosure. Furthermore, in the drawings and the description below, like numerals indicate like elements throughout.

The embodiments described herein may have implication and use in and with respect to various devices, including single- and multi-processor computing systems and vertical devices (e.g., cameras, gaming systems, appliances, etc.) that incorporate single- or multi-processing computing systems. The discussion herein is made with reference to a common computing configuration that may be discussed as an end-user system. This common computing configuration may have a CPU resource including one or more microprocessors. This discussion is only for illustration regarding sample embodiments and is not intended to confine the application of the claimed subject matter to the disclosed hardware. Other systems having other known or common hardware configurations (now or in the future) are fully contemplated and expected. With that caveat, a typical hardware and software operating environment is discussed below. The hardware configuration may be found, for example, in a server, a workstation, a laptop, a tablet, a desktop computer, a digital whiteboard, a television, an entertainment system, a smart phone, a phone, or any other computing device, whether mobile or stationary.

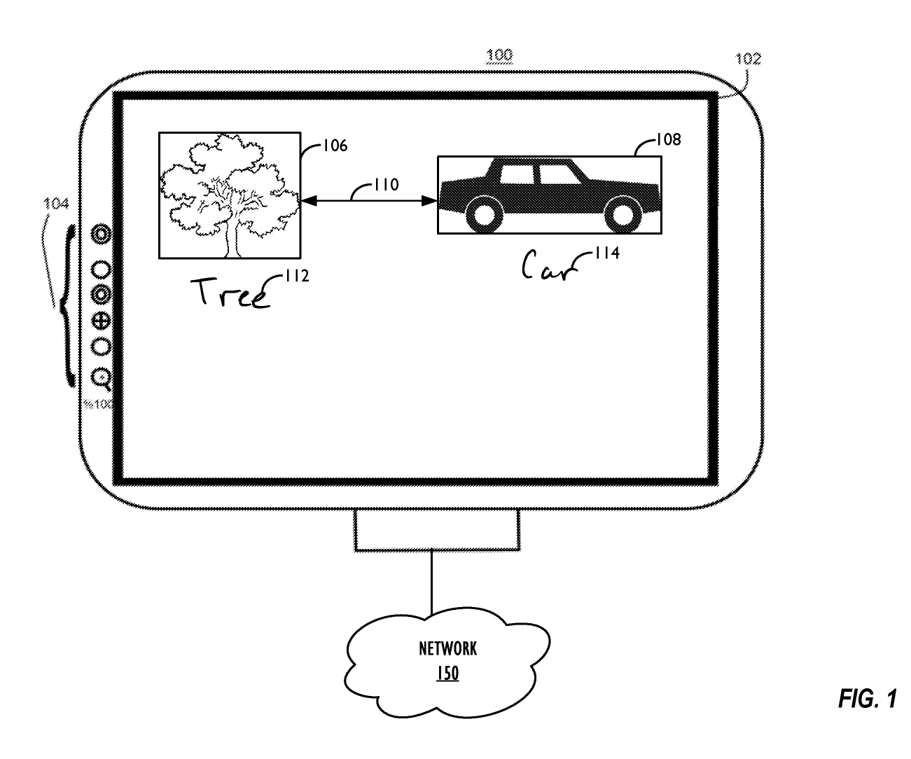

FIG. 1 illustrates an example presentation system 100. The presentation system depicted is an electronic whiteboard (or more simply ‘whiteboard’). However, the description herein applies equally well to other devices which have touch sensitive displays, or any device capable of receiving gesture type inputs and translating them into changes in displayed information, such as a tablet computer, for example. Presentation system 100 includes touch sensitive display 102 and may be connected to network 150. Network 150 may include one or more computing networks available today, such as other LANs, wide area networks (WAN), the Internet, and/or other remote networks, in order to transfer data between devices. Presentation system 100 may also include one or more inputs 104. Inputs 104 can receive input selections from one or users, such as to select marking color, zoom in on a portion of content, to save annotated content for subsequent retrieval, and to display one or more content. In the illustration, touch sensitive display 102 is being used to display content 106 and 108. Generally content may be considered a visual source of information and may be characterized by the source of the content. As examples, a webpage within a browser, video input from a camera, and an image from another device may all be separate content. In some cases, a source of content may be external and received via network 150 and selected via input 104. Here, content 106 and 108 may each be received from different external sources over network 150 and selected via input 104. In other cases, the source of certain content may be from an internal source, such as from the touch sensitive display 102.

The presentation system 100 may also receive and display annotation groups 112 and 114. Generally, annotations may be expository text, drawings, diagrams, or other markings which may be added by a user on or around other content. In some cases, content may be also be considered annotations. Typically, annotations are received from internal sources, such as the touch sensitive display 102. In some cases, annotations may also be received from external sources, such as another presentation system connected via network 150. Generally, annotations may be input in a variety of ways including through unstructured inputs such as a touch, pen, or mouse drawing input, or structured, such as typed text, selected shapes or selected lines. Annotations may be grouped together to form annotation groups.

### Global Annotations

Annotations to content allows users to expand upon and give context to the content. Relationships between the annotation and the content helps encode this information. For example, a circle by itself does not necessarily confer any significant meaning, but there may be significant meaning where the circle is around a particular piece of content. Preserving these relationship between annotations and content is thus desirable.

Certain annotations may be more relevant to one content than another. For example, for the case with two content, such as content 106 and 108, a user may add text annotation group 112 under content 106 labeling it as a tree. Likewise, the user may add text annotation group 114 under content 108 labeling it as a car. In such a case, the relationship between annotation group 112 and content 106 is more important than between, for example, annotation group 112 and content 108 or annotation group 114. In other cases, another annotation may refer to relationships between the content windows. For example, an arrow annotation 110 between content 106 and content 108 may indicate a relationship between content 106 and content 108. According to certain aspects of the present disclosure, relationships between content and annotations may be managed when moving or deleting content.

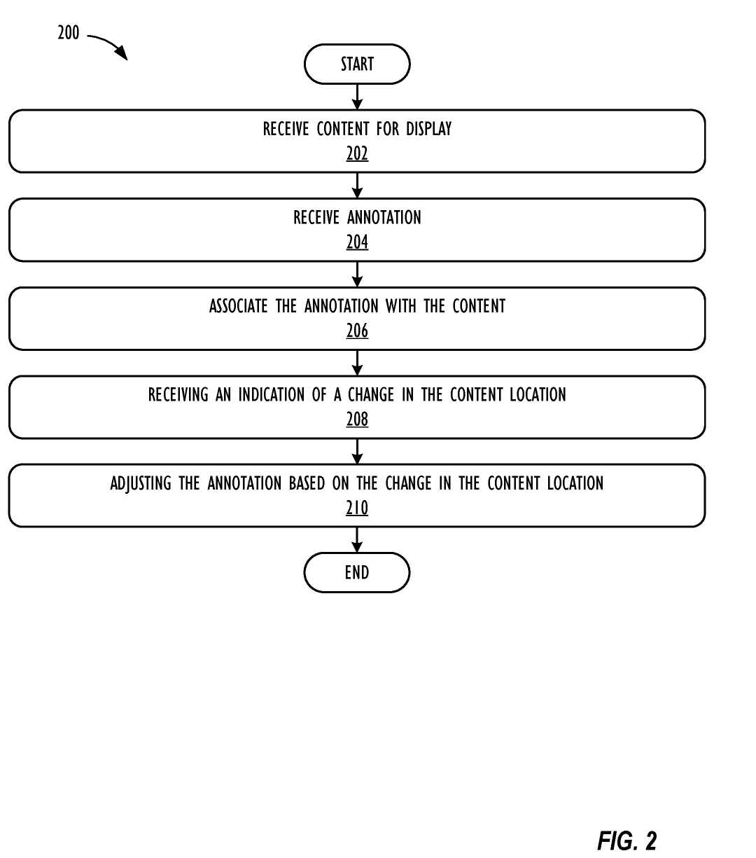

FIG. 2 is a flowchart 200 illustrating a technique for managing annotations, in accordance with aspects of the present disclosure. At step 202, a presentation system receives content for display, the content having a content location indicating a location of the content on the display. This content may be displayed at the indicated location on, for example, a digital whiteboard. The location information may also include information describing the dimensions of the content such that the presentation system is aware of what portions of the display are occupied by the content. At step 204, an annotation may be received, the annotation having an annotation location. At step 206, the annotation may be determined to be related to the content based on the annotation location and the content location. At step 208, the annotation may be associated with the content based on the determination that the content and annotation are related. At step 208, the presentation system may receive an indication changing the content location. For example, the presentation system may receive information indicating that the content is to be moved to another location or deleted. At step 210, the annotation is adjusted based on the change in the content location of the first piece of content.

As a part of managing annotations, annotations may be grouped and associated with content. For example, the presentation system may receive four separate straight drawings annotation inputs, such as strokes. These annotations may be substantially connected or overlap each other at or around endpoints of each annotation, and the presentation system may group this set of separate annotations together and recognize the inputs as forming a square shaped annotation. This square may also be recognized as surrounding a piece of content and associated with the piece of content. The presentation system may then adjust the annotations in response to changes in the piece of content, for example, moving the annotations as the location of the piece of content is moved.

Generally, a stroke is a collection of touch points {Pⱼ=(xⱼ, yⱼ)} that the touch screen registers from the moment a finger (or other instrument) touches down, till the finger lifts off. Whether a stroke is straight or curved is an important feature to take into consideration to determine the context of the writing/drawing. The straightness of a stroke {Pⱼ} is defined as the average of the distances from each point (Pⱼ) to a fitting straight line. In the simplest construction, the fitting line is merely the straight line connecting the first point (P₀) and the last point (Pₙ). Thus, the straightness (S) of a stroke is obtained according to the following equation:

$$S = {\sum }_{j = 0}^{n} \frac{‖ ( {P}_{j} - {P}_{0} ) \times ( {P}_{n} - {P}_{0} ) ‖}{n ‖ {P}_{n} - {P}_{0} ‖}$$

In which the x operator is the cross product of two vectors, and the ∥ ∥ operator is the magnitude of a vector. In a more accurate, but much more compute intensive construct, the fitting straight line can be obtained by linear regression method. In that case, the above equation still applies, with P₀ and Pₙ being replaced by the starting and ending point of the new fitting line. Thresholds may be defined around the straightness of a stroke to determine whether a stroke is approximately straight, curved, circular, etc.

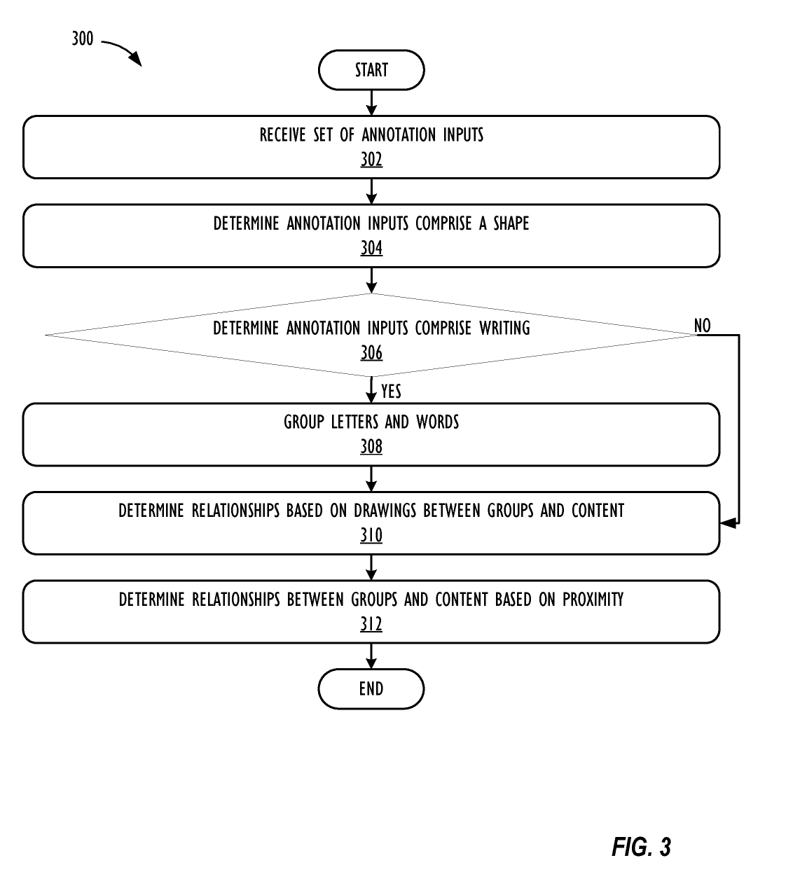

FIG. 3 is a flowchart 300 illustrating grouping and associating annotations, in accordance with aspects of the present disclosure. At step 302, one or more annotation inputs may be received as a set of annotation inputs. According to certain aspects, the set of annotation inputs may comprise one or more strokes. At step 304, the annotation inputs may be determined to be a shape. Where structured annotation input is received, such as a square shape, this determination is straightforward. Where the annotation inputs comprises drawings or strokes, common shapes may be recognized by pattern matching, proximity of endpoints of annotation inputs to each other, or other techniques. For example, as discussed above, a set of four approximately straight annotation inputs where the endpoints of each annotation input approximately touching or overlapping other endpoints of the other annotation inputs may be recognized as a square. Other examples may include an approximately circular or oval annotation inputs without sharp edges may be recognized as a circle or oval, a single stroke annotation input may be recognized as a line or curve, or a line or curve having a sharp angle or a triangle and approximately touching or overlapping with another single stroke may be recognized as an arrow. The strokes recognized as shapes may be grouped into annotation groups by shape. Generally, annotation groups may refer to groups of annotations, including shapes, words, and groups of words.

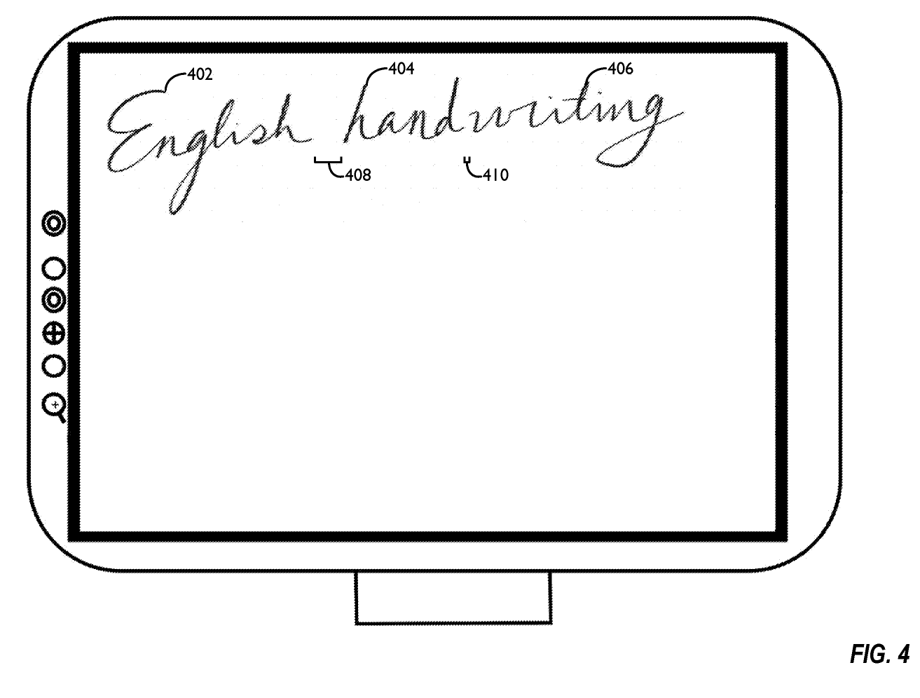

A determination may be made that the annotation inputs are writing at step 306. Where structured text is received, this determination is straightforward. For unstructured strokes, this determination may be made, for example, based on one or more of the statistics pertaining to the strokes made within a predetermined number of prior strokes or within a predetermined length of time before the current ink stroke: a) the average length of strokes, which is how long a stroke is; b) the “straightness” of strokes, which is how close a stroke follows a straight line; and c) the spatial distribution of strokes, which is how strokes which are adjacent in time are spatially distributed. Based on thresholds for average length of the strokes, and thresholds for “straightness” measurement of the strokes, handwriting of letters may be detected. These letters may be grouped into words and words into groups of words at step 308. This is discussed in more detail in conjunction with FIG. 4.

At step 310, relationships may be determined based on drawings. Relationship drawings allow groups to be connected and the nature of the connector help contextualize the relationship between connected groups. In certain cases, relationships may be inferred based on drawings. These drawings may include those recognized as shapes and relationship drawings may be based on recognized shapes. These drawings may generally appear around, under, or between previously detected annotation groups or content. For example, a line may be detected underneath two previously recognized, separate, groups of words. This line may be recognized as underlining based on the line's position relative to the two groups of words, creating a relationship between the two groups of words. A circle shape may be recognized and a determination may be made that annotation groups or content within the circle shape are related. Lines, pointers, or arrows between annotation groups or content may create relationships when they connect the annotation groups or content or when they are between annotation groups or content and point in the direction of annotation groups or content. Additionally, strokes arranged in a relatively large crisscrossing hash pattern may be recognized as a table.

In certain cases, annotation groups or content, while unconnected by any drawing, may still be related. For example, text under or next to a content window may label the content and an association between the text and the content window would be appropriate. At step 312, relationships between annotation groups and content may be determined based on their proximity to each other. A relationship may be created when annotation groups and content are within a threshold distance to one another. According to certain aspects, there may be whitespace around content or annotation groups. Annotations added to this whitespace within a threshold distance of existing content or annotations may be associated with the existing content or annotations. Additionally, annotations having a beginning point within existing content or annotations, or having an end point within existing content or annotations may also be associated with the existing content or annotations.

FIG. 4 illustrates grouping letters and words, in accordance to aspects of the present disclosure. Letters and words may be grouped together based on a distance between them. Letters may generally refer to substantially continuous or overlapping strokes with few touch removals, and may represent a single alphabetic character or sets of alphabetic characters (such as for cursive). Generally, a distance between letters is fairly consistent and smaller than the distance between words. For example, distance 408 between letter 402 and letter 404 is larger than distance 410 between letter 404 and letter 406. A dynamically adjusted average distance between letters may be maintained and recalculated for each additional distance between letters. For example, for letters 402-406, distance 408 and distance 410 may be averaged. Each additional distance between additional letters may be incorporated into this average. Each distance between letters may be compared to this average. Distances larger than the average may be recognized as being a distance between words. For example, distance 408 is larger than the average distance (as between distance 408 and distance 410) and therefore distance 408 may be recognized as dividing two separate words and based on this, letter 402 may be recognized as a word. As another example, distance 410 is smaller than the average and may be recognized as being a distance between letters. Based on this, letters 404 and 406 may be grouped as a word. In certain cases, when comparing a distance to an average distance, the distance must be greater than the average distance by a certain threshold distance to be recognized as separating words rather than letters.

Letters and words may also be grouped based on time. For example a time interval between a last stroke and a next stroke may be measured and compared against a dynamically adjusted average time between strokes. For example, the time between writing letter 402 and letter 404 may be compared to the average time between writing letters 402-406 and where the time between strokes is larger than the average time the previously written letter 402 may be recognized as separating a word and letter 402 grouped as a word. Similarly, the time between writing letters 404 and 406 may be shorter than the average time and therefore letters 404 and 406 grouped as a word. In certain cases, this time comparison may also be subject to a certain threshold time to be recognized as separating words rather than letters.

The above procedures for grouping based on time and spacing may then be repeated at the word level, based on the identified words, in order to group logical sets of words.

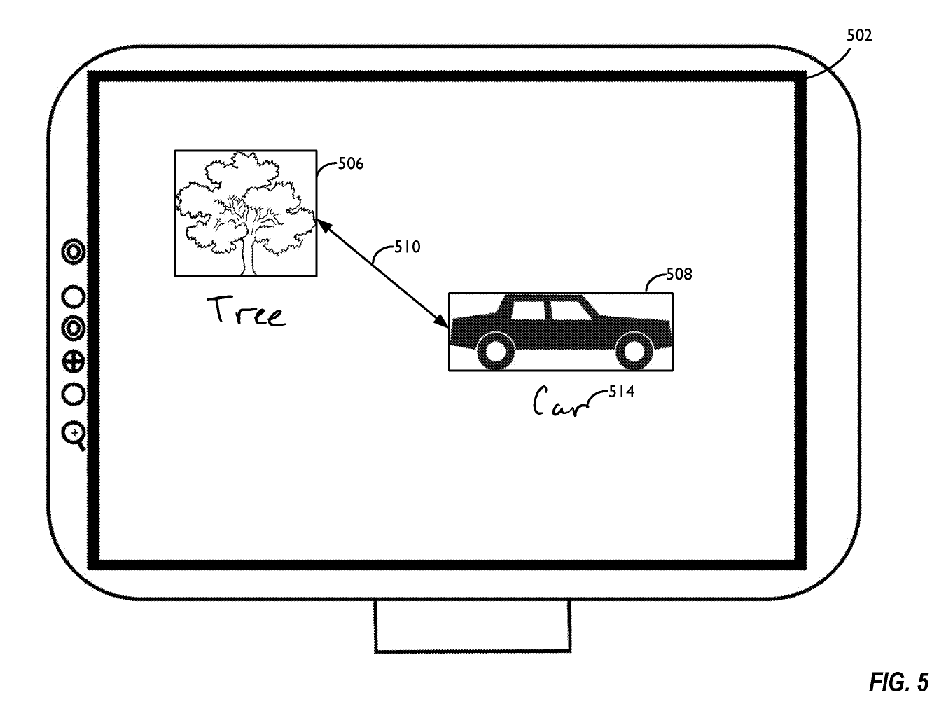

Once relationships between annotation groups and content have been determined, these relationships may be intelligently preserved even if content is moved. FIG. 5 illustrates a technique to preserve annotation relationships, in accordance with aspects of the present disclosure. Here, annotation group 514 may be an annotation group comprising strokes that have been grouped into a word. Annotation group 514 may also be associated with content 508 as annotation group 514 is in proximity to content 508. Additionally, arrow annotation 510 may be associated with both content 508 and 506.

In comparison to FIG. 1, content 508 has been moved, for example in response to an indication to change or update the location information related to content 508. In order to preserve the original relationship between annotation group 514 and content 508, the location of annotation group 514 is moved relative to the new location of content 508. Where aspects of the original relationship, such as the location of annotation group 514 relative to content 508, cannot be maintained, these aspects may be altered to minimize disruptions to the original relationship. For example, if content 508 is moved to the bottom edge of touch sensitive display 502, annotation group 514 may be moved to be above or to the side of content 508 while retaining the original distance between content 508 and annotation group 514. Relationships between annotation groups may also be retained. For example, if content 508 is moved in such a way that only a portion of annotation group 514 can be displayed, the annotation may be moved, or split, for example based on words and logical groups of words.

How the connection is maintained may be based on the connection annotation detected. For connecting annotations, such as arrow annotation 510, associated with multiple content or annotations, these annotations may be modified and redrawn based on the original intended relationships between the multiple content or annotation groups. For example, arrow annotation 510 may be associated with both content 508 and 506 and relate the content to each other and this relative connection may be preserved by redrawing the arrow annotation 510 to maintain the connection between the original location of content 506 and the new location of content 508.

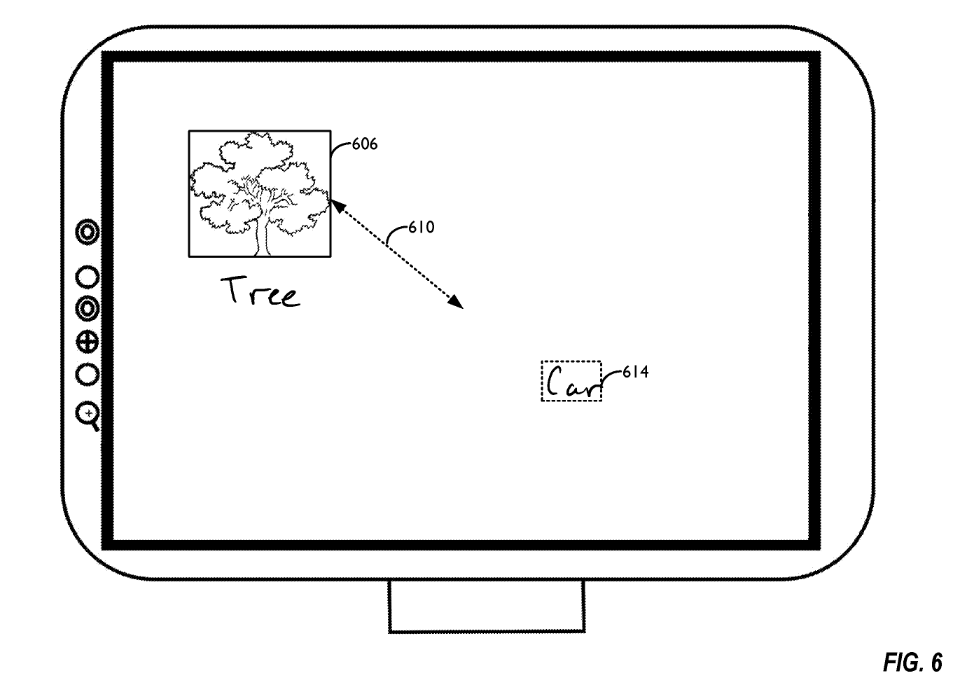

In some cases, relationships cannot be preserved. FIG. 6 illustrates a technique for broken annotation relationships, in accordance with aspects of the present disclosure. Here content corresponding to 508 of FIG. 5 has been removed. Relationships between annotations and the content may not be preserved when the content is removed. In certain cases, where these relationships are broken in such a way that the relationships cannot be preserved, the annotations having broken relationships may be identified for display to a user. For example, here the association between annotation group 614 and the removed content is broken as annotation group 614 cannot be moved in such a way as to preserve the previous proximity to the removed content. Similarly, the relationship between annotation 610 and the removed content may also not be preserved, although the relationship between annotation 610 and content 606 remains. Annotation 610 may then be displayed in such a way as to call attention to the broken relationship, such as with highlighting, outlining, or other indicator. In certain cases, annotations having broken relationships may be displayed in a way indicating how the display may be rearranged without the annotation. For example, annotation group 614 may be displayed faded as compared to prior to the removal of the content. In other cases, annotations having broken relationships may simply be removed.

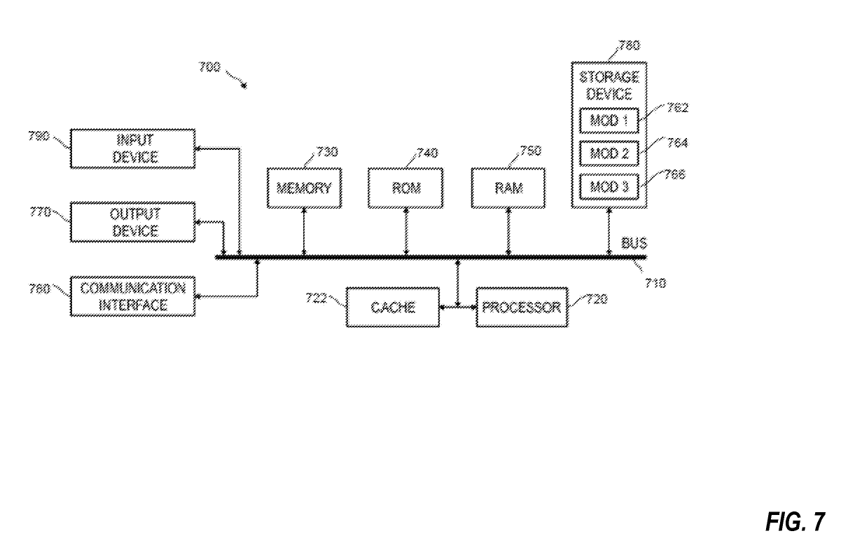

FIG. 7 illustrates an example computing device 700 which can be employed to practice the concepts and methods described above. The components disclosed herein can be incorporated in whole or in part into tablet computers, personal computers, handsets, transmitters, servers, and any other electronic or other computing device. As shown, computing device 700 can include a processing unit (CPU or processor) 720 and a system bus 710 that couples various system components including the system memory 730 such as read only memory (ROM) 740 and random access memory (RAM) 750 to the processor 720. The system 700 can include a cache 722 of high speed memory connected directly with, in close proximity to, or integrated as part of the processor 720. The system 700 copies data from the memory 730 and/or the storage device 760 to the cache 722 for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 (762), module 2 (764), and module 3 (766) stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output system (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer readable storage media provide nonvolatile storage of computer readable instructions, data structures, program modules and other data for the computing device 700. In one aspect, a hardware module that performs a particular function includes the software component stored in a non-transitory computer-readable medium in connection with the necessary hardware components, such as the processor 720, bus 710, output device 770, and so forth, to carry out the function.

Although the exemplary embodiment described herein employs the hard disk 760, other types of computer readable media which can store data that are accessible by a computer, such as magnetic cassettes, flash memory cards, digital versatile disks, cartridges, random access memories (RAMs) 750, read only memory (ROM) 740, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can comprise one or more of a number of output mechanisms, including a digital whiteboard or touchscreen. This output device may also be able to receive input, such as with a touchscreen. In some instances, multimodal systems enable a user to provide multiple types of input to communicate with the computing device 700. The communications interface 780 generally governs and manages the user input and system output. There is no restriction on operating on any particular hardware arrangement and therefore the basic features here may be substituted for improved hardware or firmware arrangements as they are developed.

For clarity of explanation, the embodiment of FIG. 7 is presented as including individual functional blocks including functional blocks labeled as a “processor” or processor 720. The functions these blocks represent may be provided through the use of either shared or dedicated hardware, including, but not limited to, hardware capable of executing software and hardware, such as a processor 720, that is purpose-built to operate as an equivalent to software executing on a general purpose processor. For example the functions of one or more processors presented in FIG. 7 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 740 for storing software performing the operations discussed below, and random access memory (RAM) 750 for storing results. Very large scale integration (VLSI) hardware embodiments, as well as custom VLSI circuitry in combination with a general purpose DSP circuit, may also be provided.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only, and should not be construed so as to limit the scope of the disclosure. Various modifications and changes can be made to the principles and embodiments described herein without departing from the scope of the disclosure and without departing from the claims which follow.

1. A presentation system, the presentation system comprising:
at least one display;
at least one processor coupled to the display; and
a memory storing instructions, the instructions comprising instructions executable by the processor to:
receive a first bit stream from a first source device and a second bit stream from a second source device;
display, on the display, a first content corresponding to the first bit stream at a first content location and a second content corresponding to the second bit stream at a second content location;
receive an annotation, the annotation having an annotation location and the annotation linking the first content to the second content;
group the annotation into an annotation group, the annotation group having a location based on the annotation location;
determine the annotation group is related to the first content and the second content based on the location of the annotation group, the first content location, and the second content location;
associate the annotation group with the first content and the second content based on the determination;
receive an indication of a change in the second content location of the second content;
adjust the annotation group based on the change in the second content location of the second content to maintain the annotation linking the first content and second content; and
display the first content and second content, based on the change in the second content location, and the adjusted annotation group.

2. The presentation system of claim 1, wherein the annotation group includes two or more annotations.

3. The presentation system of claim 2, wherein the two or more annotations comprise letters and wherein the grouping the two or more annotations comprise grouping the letters into words.

4. The presentation system of claim 3, wherein the grouping the letters into words is based on a comparison of a time or a distance between the letters between an average time or distance between letters.

5. The presentation system of claim 1, the instructions further comprising instructions executable by the processor to determine the annotation group is a shape based at least in part on a stoke shape of the annotation group.

6. The presentation system of claim 1, the instructions further comprising instructions executable by the processor to determine the annotation group is a relationship drawing based at least in part on a stroke shape of the annotation group and the location of the annotation group relative to a target content.

7. The presentation system of claim 6, wherein the location of the annotation group relative to the target content comprises one of: above the target content, beside the target content, below the target content, around the target content, or between the target content and another content.

8. The presentation system of claim 1, the instructions further comprising instructions executable by the processor to display a third content on the display based on a third content location.

9. The presentation system of claim 8, the instructions further comprising instructions executable by the processor to determine the annotation group is related to the third content based on the location of the annotation group and the third content location.

10. The presentation system of claim 9, wherein adjusting the annotation group is further based in part of the location of the third content.

11. The presentation system of claim 10, wherein adjusting the annotation group comprises adjusting the shape or size of the annotation group.

12. The presentation system of claim 11, wherein the shape or size of the annotation group is adjusted to maintain relationships between the annotation group, the content, and the other content.

13. The presentation system of claim 1, wherein adjusting the annotation group comprises adjusting the location of the annotation group based on the change in the second content location.

14. The presentation system of claim 1, wherein the indication of a change in the second content location indicates that the second content is deleted, and wherein adjusting the annotation comprises displaying a notification that the annotation group is no longer related to the second content.

15. A method for preserving annotation relationships, the method comprising:
receiving a first bit stream from a first source device and a second bit stream from a second source device;
displaying, on a display, a first content corresponding to the first bit stream at a first content location and a second content corresponding to the second bit stream at a second content location;
receiving an annotation, the annotation having an annotation location and the annotation linking the first displayed content to the second displayed content;
grouping the annotation into an annotation group, the annotation group having a location based on the annotation location;
determining the annotation group is related to the first content and the second content based on the location of the annotation group, the first content location, and the second content location;
associating the annotation group with the first content and the second content based on the determination;
receiving an indication of a change in the second content location of the second content;
adjusting the annotation group based on the change in the second content location of the second content to maintain the annotation linking the first content and second content; and
displaying the first content and the second content, based on the change in the second content location, and the adjusted annotation group.

16. The method of claim 15, wherein the annotation group includes two or more annotations.

17. The method of claim 16, wherein the two or more annotations comprise letters and wherein the grouping the two or more annotations comprise grouping the letters into words.

18. The method of claim 17, wherein the grouping the letters into words is based on a comparison of a time or a distance between the letters between an average time or distance between letters.

19. The method of claim 15, further comprising determining the annotation group is a shape based at least in part on a stoke shape of the annotation group.

20. The method of claim 15, further comprising determining the annotation group is a relationship drawing based at least in part on a stroke shape of the annotation group and the location of the annotation group relative to a target content.

21. The method of claim 20, wherein the location of the annotation group relative to the target content comprises one of: above the target content, beside the target content, below the target content, around the target content, or between the target content and another content.

22. The method of claim 15, further comprising displaying a third content on the display based on a third content location.

23. The method of claim 22, further comprising determining the annotation group is related to the third content based on the location of the annotation group and the third content location.

24. The method of claim 23, wherein adjusting the annotation group is further based in part of the location of the third content.

25. The method of claim 24, wherein adjusting the annotation group comprises adjusting the shape or size of the annotation group.

26. The method of claim 25, wherein the shape or size of the annotation group is adjusted to maintain relationships between the annotation group, the content, and the other content.

27. The method of claim 15, wherein adjusting the annotation group comprises adjusting the location of the annotation group based on the change in the second content location.

28. The method of claim 15, wherein the indication of a change in the second content location indicates that the second content is deleted, and wherein adjusting the annotation comprises displaying a notification that the annotation group is no longer related to the second content.

29. The presentation system of claim 1, the instructions further comprising instructions executable by the processor to:
cease display of the first content and linking annotation;
display a third content in a third location, the third location at least partially overlapping the first content location;
cease displaying the third content; and
resume displaying the first content and linking annotation at the first location based on the association of the annotation group with the first content and the second content.

30. The method of claim 15, further comprising:
ceasing display of the first content and linking annotation;
displaying a third content in a third location, the third location at least partially overlapping the first content location;
ceasing displaying the third content; and
resuming displaying the first content and linking annotation at the first location based on the association of the annotation group with the first content and the second content.
